(19) United States
(12) Patent Application Publication
(10) Pub. No.: US 2011/0150381 A1
(43) Pub. Date: Jun. 23, 2011

(54) BEARING INSTALLATION STRUCTURE AND INSTALLATION METHOD

(75) Inventors: Koichi MATSUMOTO, Tochigi (JP); Teruaki KOBAYASHI, Tochigi (JP); Hiroshi MIWA, Tochigi (JP)

(73) Assignee: HONDA MOTOR CO., LTD., Tokyo (JP)

(21) Appl. No.: 12/967,327

(22) Filed: Dec. 14, 2010

(30) Foreign Application Priority Data
Dec. 21, 2009 (JP) 2009-289513

(51) Int. Cl. F16C 33/58; B21D 53/10

(52) U.S. Cl. 384/517; 29/898.062

(57) ABSTRACT

An installation structure of bearings and an installation method are provided that can reduce the amount of damage caused by tightening bearings supporting a fulcrum shaft that pivotally supports a gun arm, as well as simplify operation and maintenance. One race is fixed among an inner race and an outer race constituting a bearing, which supports a fulcrum shaft (30) pivotally supporting a first gun arm (11) and a second gun arm (12) constituting a welding gun (10) to be rotatable, and relates to an installation structure (38) of bearings that receive a combined load of an axial load acting in an axial direction of the fulcrum shaft (30) and a radial load acting in a radial direction thereof. The other race among the inner race and outer race constituting the bearing is installed in the radial direction to be movable in a direction in which there is no longer a radial gap or axial gap between the inner race, outer race and a revolving body disposed between the outer race and the inner race to revolve freely.

This application is based on and claims the benefit of priority from Japanese Patent Application No. 2009-289513, filed on 21 Dec. 2009, the content of which is incorporated herein by reference.

### BACKGROUND OF THE INVENTION

1. Field of the Invention

The present invention relates to an installation structure of bearings supporting a fulcrum shaft that pivotally supports a gun arm, and an installation method thereof. More specifically, the present invention relates to an installation structure of bearings that reduces the damage occurring due to tightening bearings, and makes operation and maintenance easy.

2. Related Art

Conventionally, roller bearings have been used as bearings supporting a fulcrum shaft for pivotally supporting gun arms of an X-type welding gun provided with electrode tips at the leading ends thereof (e.g., refer to Japanese Unexamined Patent. Application Publication No. 2002-178160). In such gun arms, pretension is applied to the bearings supporting the fulcrum shaft, so as to raise the rigidity of the bearings and thus reduce vibration of the fulcrum shaft, thereby preventing the vibration transferring to the electrode portions provided in the leading ends of the gun arms. Therefore, in a case of using roller bearings as bearings of the fulcrum shaft, it is necessary to impart pretension to the bearings in order to prevent vibration of the leading ends of the gun arms. As a result thereof, such roller bearings have been made in a pretension-structure in which the bearings are tightened with a constant pressure using a bearing nut.

### SUMMARY OF THE INVENTION

However, torque management of the pretension force imparted to this pretension structure requires special tools such as a torque wrench. As a result, when a tightening load higher than prescribed is applied to a bearing as a result of imparting a pretension force by using a regular tightening tool such as a spanner, an excessive load may be applied to a casting, which is a structure having the bearing installed therein, and cause the casting to be damaged. In addition, the bearing service life may be considerably reduced as a result of applying a pretension force higher than prescribed to the bearing. The above fact may cause the operation and maintenance for maintaining bearings to be complicated, as well as a production line employing machines provided with bearings to be stopping due to operation and maintenance or repair of damage, thereby inviting a decline in the rate of operation of the production line.

It is an object of the present invention to provide an installation structure of bearing and an installation method thereof that can reduce the damage occurring from tightening bearings that support a fulcrum shaft, as well as facilitating the operation and maintenance of the bearing.

According to an installation structure of bearings of the present invention, in an installation structure of a bearing that supports a fulcrum shaft pivotally supporting a gun arm constituting a welding gun to be rotatable, and receiving a combined load of an axial load acting in an axial direction of the fulcrum shaft and a radial load acting in a radial direction of the fulcrum shaft, one race among an inner race and an outer race constituting the bearing is fixed in an axial direction, and an other race among the inner race and the outer race is installed to be movable, relative to the one race among the inner race and the outer race, in a direction in which there is no longer a radial gap or axial gap between a revolving body, disposed between the inner race and the outer race to freely revolve, and the inner race and the outer race.

According to the present invention, one among the inner race and the outer race is fixed in the axial direction, and the other one among the inner race and outer race that is not fixed is movable in a direction in which there is no longer a radial gap or axial gap between the inner race, outer race and revolving body in the axial direction. Therefore, in a case of the outer race of a bearing being set as the one that is fixed, since the inner race, which is the other one, will be movable in the axial direction, the inner race, which is the other one, will shift in the axial direction relative to the outer race from tightening the bearing. As a result thereof, due to the one among the inner race and outer race of the bearing being fixed, and the other one providing a gap in the axial direction, the inner race and the outer race will mutually shift from tightening the bearing, and there will no longer be play in the bearing, even if a large amount of torque is not applied when the bearing is tightened. Therefore, since the bearing can be fixed with a small amount of torque, it is possible to reduce the damage to a casting in which a bearing is installed. In addition, since play in the bearing can be prevented by simply fixing the bearing with a small amount of torque, it is possible to reduce the time spent in operation and maintenance for repairing bearings, and make a structure for which operation and maintenance is easy.

In this case, it is desirable to install a conical spring between tightening means that tighten and fix the bearing so as to support the fulcrum shaft relative to the gun arms.

According to the present invention, it is possible to make a structure for which torque management is easy, since the torque from tightening can be simply calculated by measuring a compression amount of the conical spring from a dimension of the conical spring that changes from tightening, or the like. In addition, since the biasing force generated by the conical sprint is constant after tightening, it is possible to prevent a tightening load above a specified amount from acting on the bearing by managing the dimension of the conical spring, which changes by compression. Furthermore, since pretension management can be performed simply by tightening so that the height of the conical spring is a constant dimension, a technician that performs maintenance in a production line in which welding guns including bearings are provided can easily manage the bearings at the pretension amount that had been specified, without requiring special tools.

According to a method for installing bearings of the present invention, in a method for installing a bearing that supports a fulcrum shaft pivotally supporting a gun arm constituting a welding gun to be rotatable, and receives a combined load of an axial load acting in an axial direction of the fulcrum shaft and a radial load acting in a radial direction of the fulcrum shaft, the method includes steps of: fixing one race, among an inner race and an outer race constituting the bearing, in an axial direction; installing an other race among the inner race and the outer race to be movable in the axial direction; causing the other race among the inner race and the outer race to move relative to the one race among the inner race and the outer race when assembling the bearing; shifting the inner race and the outer race relatively in the axial direction; and fixing in a state in which there is no longer a radial gap or axial gap between a revolving body, disposed between the inner race and the outer race to freely revolve, and the inner race and the outer race, respectively.

According to the present invention, one race among the inner race and the outer race is fixed in the axial direction, and the other race among the inner race and the outer race that is not fixed is movable in a direction in which there is no longer a radial gap or axial gap between the inner race, the outer race and the revolving body in the axial direction. Therefore, in a case of the outer race of the bearing having been set as the one fixed, since the inner race, which is the other one, is movable in the axial direction, the inner race, which is the other one, will shift in the axial direction relative to the outer race, from tightening the bearing. As a result thereof, due to the one among the inner race and outer race of the bearing being fixed, and the other one providing a gap in the axial direction, the inner race and the outer race will mutually shift from tightening the bearing, and there will no longer be play in the bearing, even if a large amount of torque is not applied when tightening the bearing. Therefore, since the bearing can be fixed with a small amount of torque, it is possible to reduce the damage to a casting in which a bearing is installed. In addition, since play in the bearing can be prevented by simply fixing the bearing with a small amount of torque, it is possible to reduce the time spent in operation and maintenance for repairing bearings, and make a structure for which operation and maintenance is easy.

In this case, it is desirable to tighten the bearing in a state in which a conical spring is installed between tightening means that tighten and fix the bearing so as to support the fulcrum shaft relative to the gun arm.

According to the present invention, it is possible to make a structure for which torque management is easy, since the torque from tightening can be simply calculated by measuring a compression amount of the conical spring such as a dimension of the conical spring that changes from tightening, or the like. In addition, since the biasing force generated by the conical spring is constant after tightening, it is possible to prevent a tightening load above a specified amount from acting on the bearing by managing the dimension of the conical spring, which changes by compression. Furthermore, since pretension management can be performed simply by tightening so that the height of the conical spring is a constant dimension, a technician that performs maintenance in a production line in which welding guns including bearings are provided can easily perform manage the bearings at the pretension amount that had been specified, without requiring special tools.

According to the present invention, it is possible to reduce damage, while making operation and maintenance on bearings supporting a fulcrum shaft that pivotally supports a gun arm easy.

### BRIEF DESCRIPTION OF THE DRAWINGS

FIG. 1 is a three-dimensional side view of a welding gun provided with bearings installed as an installation structure of bearings according to an embodiment of the present invention;

FIG. 2 is a cross-sectional view, taken along a cross-section A-A of the welding gun in FIG. 1;

FIG. 3 is partially enlarged cross-sectional view showing inside of a bearing installed as the installation structure in FIG. 1;

FIG. 4 is a partially enlarged cross-sectional view showing inside of a conical spring contacting with a bearing installed as the installation structure in FIG. 1; and

FIG. 5 is a partially enlarged cross-sectional view showing inside of a bearing installed as the installation structure in FIG. 1.

### DETAILED DESCRIPTION OF THE INVENTION

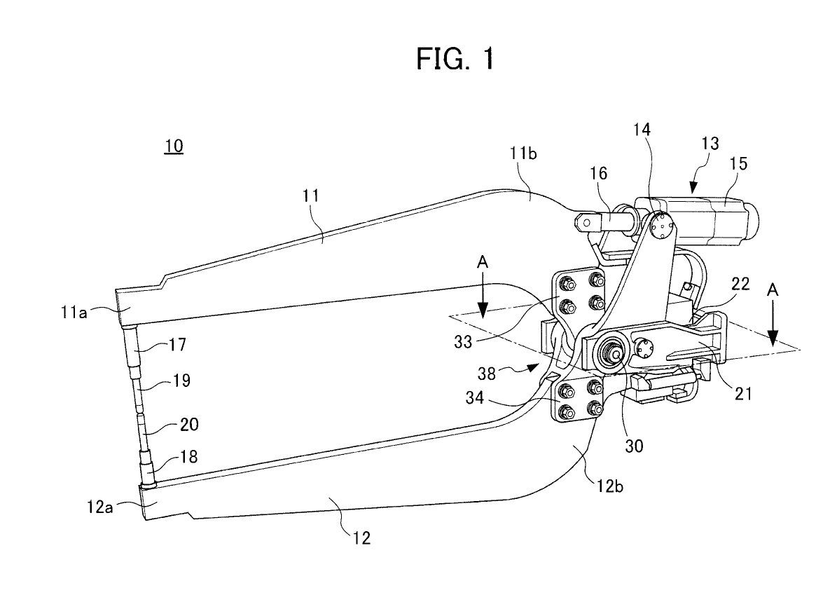

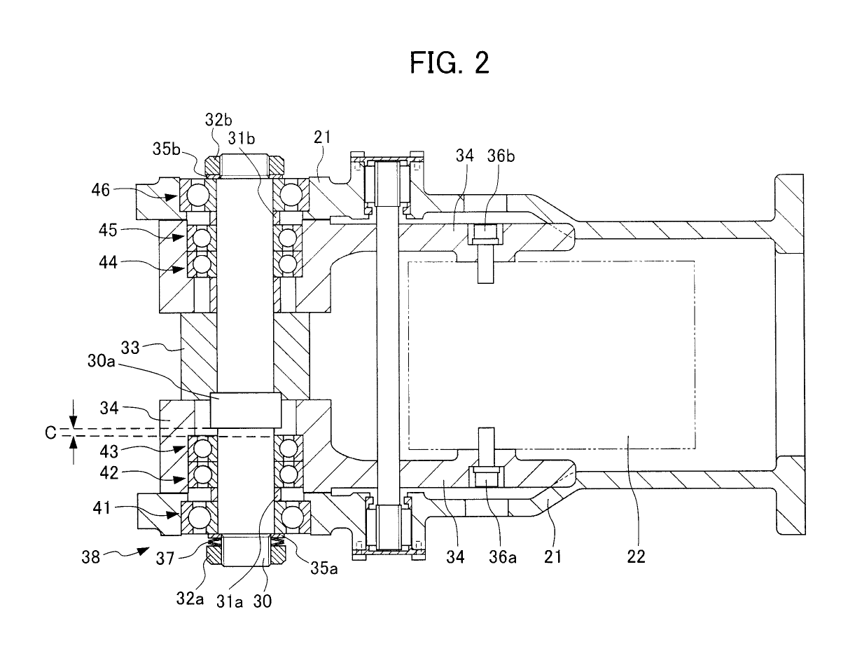

FIG. 1 is a three-dimensional side view of a welding gun 10 provided with bearings installed as an installation structure 38 of bearings according to an embodiment of the present invention. The welding gun 10 shown in FIG. 1 is used to be mounted on a leading end of a robot arm and designed to pivotally support an upper and lower pair of gun arm, which are constituted by a first gun arm 11 and a second gun arm 12 that open and close by way of an pneumatic cylinder 13, at a fulcrum shaft 30 provided at a leading end of a gun bracket 21 attached to the leading end of the arm of the robot that is not illustrated. Furthermore, the welding gun 10 is adapted to move a plurality of spot positions on a work (not illustrated) sequentially and perform welding, as described below. As shown in FIG. 2, the gun arms are pivotally supported by a plurality of bearings including a first bearing 41, a second bearing 42, a third bearing 43, a fourth bearing 44, a fifth bearing 45 and a sixth bearing 46 at the fulcrum shaft 30. In particular, the first bearing 41, the second bearing 42 and the third bearing 43 are installed as an installation structure 38 according to the present embodiment. The bearings installed as this installation structure 38 pivotally support the upper and lower pair of gun arms constituted by the first gun arm 11 and the second gun arm 12, which open and close by way of the pneumatic cylinder 13.

The welding gun 10 is constituted as an X-type welding gun that opens and closes between a first electrode tip 19 and a second electrode tip 20 provided to the leading ends of the first gun arm 11 and second gun arm 12, respectively, by opening and closing the first gun arm 11 and the second gun arm 12 fixed to each other with the fulcrum shaft 30 supported by a plurality of bearings in this way as a pivot point.

The first gun arm 11 includes a first electrode tip 19 with a first tip holder 17 at the leading end portion 11a thereof. Similarly, the second gun arm 12 includes a second electrode tip 20 with a second tip holder 18 at a leading end portion 12a thereof. The first gun arm 11 is connected with a leading end portion of a first frame 33 at a trailing end portion 11b thereof. Similarly, the second gun arm 12 is connected with a leading end portion of a second frame 34 at a trailing end portion 12b. In addition, the first gun arm 11 and the second gun arm 12 are pivotally supported by the first bearing 41, the second bearing 42, the third bearing 43, the fourth bearing 44, the fifth bearing 45 and the sixth bearing 46, which are described later with reference to FIG. 2, to freely open and close with the fulcrum shaft 30, which is passing through and pivotally supported by substantially central parts of trailing end portions of the first frame 33 and the second frame 34, as a pivot point.

The pneumatic cylinder 13 is provided with a cylinder main body 15 and a piston rod 16 that is formed to freely project and retract from the cylinder main body 15. The leading end of the piston rod 16 is pivotally supported at the trailing end portion 11b of the first gun arm 11 to be rotatable, and the leading end of the cylinder main body 15 is pivotally supported with the pneumatic cylinder fixed shaft 14 by a trailing end portion of the second frame 34, which is connected to the second gun arm 12. Spot welding of a work can be performed by causing the piston rod 16 of the pneumatic cylinder 13 to move toward a projecting side, thereby closing the first gun arm 11 and the second gun arm 12 and sandwiching the work between the first electrode 19 and the second electrode tip 20 provided between the first gun arm 11 and the second gun arm 12, and then flowing electrical current between the first electrode tip 19 and the second electrode tip 20 in this state.

In addition, a transformer 22 for supplying electrical power to the first electrode tip 19 and the second electrode tip 2C is disposed at the trailing end portion of the second frame 34. As shown in FIG. 2, the transformer 22 is fixed by fixing threads 36a and 36b provided in both side ends of the second frame 34.

Operation of the welding gun 10 having the installation structure 38 according to the embodiment of the present invention constructed in the above way will be explained. First, in order to make the welding gun 10 enter a closed state from an opened state, air can be supplied to the pneumatic cylinder 13 at a predetermined pressure to cause the piston rod 16 to perform a projecting motion.

The piston rod 16 of the pneumatic cylinder 13 is pivotally supported at the trailing end portion 11b of the first gun arm 11, and the first gun arm 11 is pivotally supported with the fulcrum shaft 30 by the first frame 33. Therefore, when the piston rod 16 is caused to perform a projecting motion, the first gun arm 11 can pivot the leading end portion 11a of the first gun arm 11 toward the leading end portion 12a of the second gun arm 12 with the fulcrum shaft 30 as the pivot point.

Similarly, the cylinder main body 15 of the pneumatic cylinder 13 is pivotally supported by the trailing end portion 12b of the second gun arm 12 with the trailing end portion of the second frame 34, and the second gun arm 12 is pivotally supported with the fulcrum shaft 30 by a central part of the second frame 34. Therefore, when the piston rod 16 is caused to perform a projecting motion, the second gun arm 12 can pivot the leading end portion 12a of the second gun arm 12 towards the leading end portion 11a of the first gun arm 11 with the fulcrum shaft 30 as the pivot point, since the cylinder main body 15 moves toward the side opposite to the projecting side of the piston rod 16.

FIG. 2 is a cross-sectional view taken along a cross-section A-A of the welding gun 10 in FIG. 1. As shown in FIG. 2, the fulcrum shaft 30 of the welding gun 10 is pivotally supported by a plurality of bearings including the first bearing 41, the second bearing 42, the third bearing 43, the fourth bearing 44, the fifth bearing 45 and the sixth bearing 46. The first bearing 41, the second bearing 42, the third bearing 43, the fourth bearing 44, the fifth bearing 45 and the sixth bearing 46 are installed so as to receive the combined loads composed of both the axial load acting in the axial direction of the fulcrum shaft 30, and the radial load acting in the radial direction thereof.

The first bearing 41 and the sixth bearing 46 are each disposed inside of a gun bracket 21, and the second bearing 42, fifth bearing 45, third bearing 43 and fourth bearing 44 are each disposed in series inside the second frame 34. Then, a first collar 31a and a second collar 31b of short-cylindrical shape are installed between the first bearing 41 and the second bearing 42, and between the sixth bearing 46 and the fifth bearing 45, respectively.

The fulcrum shaft 30 is passing through and installed in each of the first bearing 41, the first collar 31a, the second bearing 42, the third bearing 43, an inner space of the first frame 33, the fourth bearing 44, the fifth bearing 45, the second collar 31b, and the sixth bearing 46 in this order. In addition, U-nuts 32a and 32b are installed as tightening means that tighten and fix the first bearing 41 and the sixth bearing 46 with the fulcrum shaft 30 with respect to the second gun arm 12 of the welding gun 10 at both ends of the fulcrum shaft 30. After the U-nut 32b is attached to one end of the fulcrum shaft 30 in advance, the fulcrum shaft 30 can be fixed applying pretension to the first bearing 41, the second bearing 42, the third bearing 43, the fourth bearing 44, the fifth bearing 45 and the sixth bearing 46, which are installed between the U-nuts 32a and 32b, by tightening the U-nut 32a at the other end of the fulcrum shaft 30.

The conical springs 37 and the washer 35a, which is disposed between a conical spring 37 and the first bearing 41, are installed between the first bearing 41 and the U-nut 32a. The conical springs 37 have elasticity in the axial direction, and thus contract a predetermined dimension in the axial direction of the fulcrum shaft 30 every time when the U-nut 32a is tightened. Consequently, the contracted conical springs 37 press an inner race 41a of the first bearing 41 through a washer 35a, with a resilience according to the dimension of the conical springs 37 that has been deformed due to contraction.

Therefore, pretension can be applied to each of the first bearing 41, the second bearing 42, the third bearing 43, the fourth bearing 44, the fifth bearing 45 and the sixth bearing 46, which are installed between the U-nuts 32a and 32b, by tightening the U-nuts 32a and 32b installed at both ends of the fulcrum shaft 30.

The first bearing 41, the second bearing 42 and the third bearing 43, which are installed as an installation structure 38 according to the present embodiment, are separated by a gap C up to a step 30a in the fulcrum shaft 30, whereby portions of the first bearing 41, the second bearing 42 and the third bearing 43 are allowed to slide by only the distance of this gap C. In addition, the conical springs 37 are installed between the first bearing 41 and the U-nut 32a. As a result, the torque acting on each bearing among the first bearing 41, the second bearing 42 and the third bearing 43 due to tightening can be simply calculated by measuring the compressed dimension of the conical springs 37, which changes by tightening. Therefore, management of the torque acting on each bearing among the first bearing 41, the second bearing 42 and the third bearing 43 can be made easy. Hereinafter, the installation structure 38 according to the present embodiment will be explained in detail with reference to the first bearing 41.

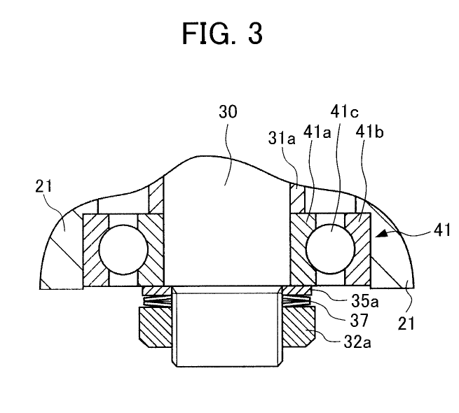

As shown in FIG. 3, the first bearing 41 is constructed by an inner race 41a, an outer race 41b and revolving bodies 41c of a spherical shape that are arranged to revolve freely between the inner race 41a and the outer race 41b. The outer race 41b constituting the first bearing 41 is fittedly connected and fixed with inside of the gun bracket 21, and is installed to not be able to move in the axial direction of the fulcrum shaft 30. In contrast, the inner race 41a constituting the first bearing 41 is movable only by the distance of the aforementioned gap C in the axial direction of the fulcrum shaft 30. This means that the inner race 41 is installed to be movable in a direction in which there is no longer an axial gap or radial gap, up to a maximum of the distance of the aforementioned gap C in the axial direction of the fulcrum shaft 30 when the U-nuts 32a and 32b provided to the fulcrum shaft 30 are tightened. In order to make the inner race 41a movable in the axial direction of the fulcrum shaft 30, it is necessary for a force applied to the washer 35a to transfer to the inner race 41a without being hindered by the fulcrum shaft 30. Therefore, the fulcrum shaft 35a may be shaped with a reduced-diameter part at an end thereof such that it is reduced in diameter on the side of the washer 35a so that the washer 35a only abuts with the inner race 41a, for example. In this case, the length of the reduced-diameter part formed with the fulcrum shaft 30 would be set to be at least substantially equal to the distance of the gap C. However, the present invention is not limited thereto, and it should be understood by those skilled in the art that not only forming a reduced-diameter part in the fulcrum shaft 30, but various constitutions are possible to achieve a similar effect as the reduced-diameter part.

When assembling the first bearing 41 constituting the installation structure 38 according to the present embodiment, among the inner race 41a and the outer race 41b constituting the first bearing 41, the outer race 41b is fittedly connected and fixed first with inside of the gun bracket 21. Next, among the inner race 41a and outer race 41b constituting the first bearing 41, the outer race 41b is shifted towards the center position in the axial direction of the fulcrum shaft 30, and then the U-nuts 32a and 32b provided to the fulcrum shaft 30 are tightened and fixed in a state in which there is no longer axial gap or radial gap.

Herein, the outside diameter dimension of the first collar 31a, which is installed on a center side in the axial direction of the fulcrum shaft 30 relative to the first bearing 41, is formed to be smaller than the outside diameter dimension of the inner race 41a of the first bearing 41, and the first collar 31a is installed so as to abut only with the inner race 41a in the first bearing 41. In addition, the washer 35a and a pair of the conical springs 37 disposed facing toward each other are provided between the first bearing 41 and the U-nut 32a.

The outside diameter dimensions of the washer 35a and the conical springs 37, which are provided on a center side in the axial direction of the fulcrum shaft 30 relative to the U-nut 32a, are smaller than the outside diameter dimension of the inner race 41a of the first bearing 41. With this, the U-nut 32a is installed so as to only abut with the outer side of the inner race 41a in the first bearing 41 through the conical springs 37 and the washer 35a. The outside diameter dimension of the first collar 31a, which is installed on a center side in the axial direction of the fulcrum shaft 30 relative to the first bearing 41, is formed to be smaller than the outside diameter dimension of the inner race 41a in the first bearing 41. With this, the first collar 31a is installed so as to abut with the inside of the inner race 41a in the first bearing 41. Therefore, by tightening the U-nut 32a, the force tightening the U-nut 32a can be transmitted through the conical springs 37 and the washer 35a to the inner race 41a constituting the first bearing 41. In the present embodiment, the fulcrum shaft 30 can be tightened by tightening the U-nut 32b first, and tightenings the U-nut 32a later.

While the first bearing 41 has been explained in the above, the sixth bearing 46 is installed according to the same structure. However, it is not required for a conical spring 37 to necessarily be installed for the sixth bearing 46. It is sufficient if at least either one among the first bearing 41 and the sixth bearing 46 is installed to be adjacent to a conical spring 37 with either the washer 35a or the washer 35b. In addition, the second bearing 42, the fifth bearing 45, the third bearing 43 and the fourth bearing 44 are also installed substantially in the same structure as the first bearing 41; however, the second bearing 42, the fifth bearing 45, the third bearing 43 and the fourth bearing 44 are different from the first bearing 41 in that the outer race 41b of the first bearing 41 is fittedly connected with inside the gun bracket 21; whereas, the outer races respectively constituting the second bearing 42, the fifth bearing 45, the third bearing 43 and the fourth bearing 44 are fittedly connected and fixed with inside the second frame 34, and installed so as not to be movable in the axial direction of the fulcrum shaft 30.

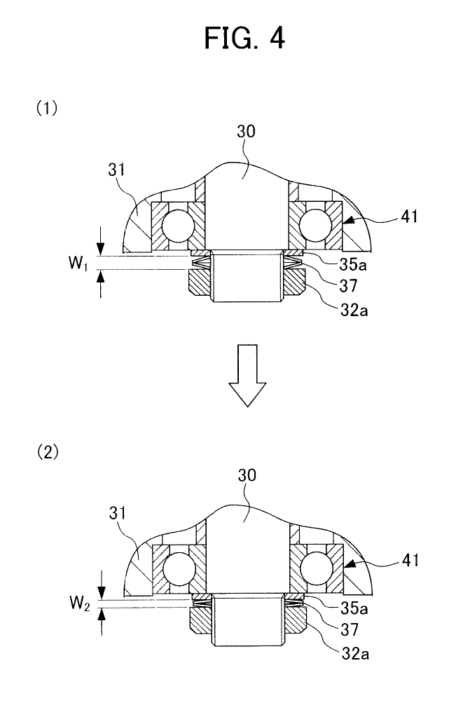

The effects of the conical springs 37 installed between the first bearing 41 and the U-nut 32a while tightening the U-nut 32a will be explained with reference to FIG. 4. FIG. 4(1) is a view showing a state of the conical springs 37 before the U-nut 32a is tightened. FIG. 4(2) is a view showing a state of the conical springs 37 after the U-nut 32a is tightened.

As shown in FIG. 4(1), before the U-nut 32a is tightened, the conical springs 37 are not compressed to the side of first bearing 41 in the axial direction of the fulcrum shaft 30; therefore, the conical springs 37 maintain a dimension W1. Herein, in a case of having tightened the U-nut 32a, the conical springs 37 are pressed to the side of the first bearing 41 in the axial direction of the fulcrum shaft 30 by the U-nut 32a. As a result thereof, the conical springs 37 installed between the U-nut 32a and the washer 35a abutting against the inner race 41a of the first bearing 41 are compressed to a dimension W2.

The conical springs 37 compressed in the axial direction contract in the axial direction of the fulcrum shaft 30 between the U-nut 32a and the washer 35a every time when the U-nut 32a is tightened. Then, since the conical springs 37 have elasticity in the axial direction of the fulcrum shaft 30, the conical springs 37 press the inner race 41a of the first bearing 41 via the washer 35a with a pretension force corresponding to the contracted dimension as a resilience against contraction.

In addition, although not illustrated, in a case of having tightened the U-nut 32a installed on one side of the fulcrum shaft 30, the resilience against contraction of the conical springs 37 act in a direction pulling the U-nut 32b installed on the other side of the fulcrum shaft 30 to the center side in the axial direction, similarly to the side of the first bearing 41. Therefore, in this case, the U-nut 32b presses the inner race of the sixth bearing 46 through the washer 35b abutting the U-nut 32b to a center side in the axial direction.

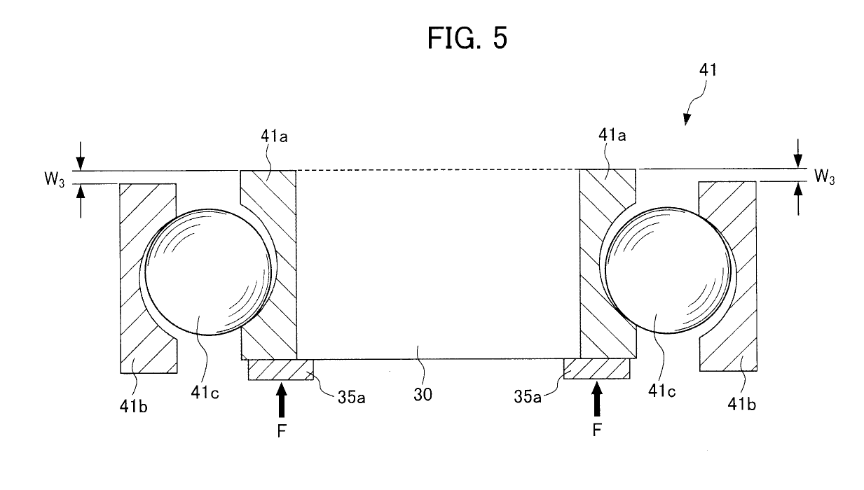

Next, effects when pressing the inner race 41a of the first bearing 41 via the washer 35a by means of the resilience of the conical springs 37 will be explained with reference to FIG. 5.

In a case in which the conical springs 37 installed between the first bearing 41 and the U-nut 32a are compressed as a result of tightening the U-nut 32a, the conical springs 37 cause the inner race 41a of the first bearing 41 to move via the washer 35a by a predetermined dimension W3 to a center side in the axial direction by the resilience F thereof. In contrast, the outer race 41b is fixed to the gun bracket 21, and further, the conical springs 37 and washer 35a abut only with the inner race 41a of the first bearing 41, and do not abut with the outer race 41b; therefore, the outer race 41b will not move in the axial direction, even when the U-nut 32a is tightened. As a result, the inner race 41a of the first bearing 41 will shift by the predetermined dimension W3 in the axial direction relative to the outer race 41b. Since the resilience F of the conical springs 37 required to yield this predetermined dimension W3 can be simply calculated by measuring the compressed dimension of the conical springs 37, which changes by tightening, torque management can be made easy.

Accordingly, as the first bearing 41 is tightened with the U-nut 32a, the inner race 41a and the outer race 41b mutually shift while the inner race and outer race of the second bearing 42 mutually shift. Therefore, the play in each bearing can be eliminated, even if a large amount of torque is not applied when the bearings is tightened. It should be noted that, since the remaining second bearing 42 and third bearing 43 are also similar, explanations thereof are omitted.

Therefore, it is possible to fix each bearing with a small amount of torque without applying excessive torque on each bearing, and thus it is possible to achieve a reduction in damage to a casting of the welding gun in which bearings are installed. As a result thereof, the time spent in order to perform operation and maintenance of a welding gun in which bearings are installed can be reduced and the operation and maintenance can be made easy.

It should be noted that, although among the inner race 41a and the outer race 41b constituting the first bearing 41, the outer race 41b is set to be the fixed one, and the inner race 41a, which is the other one, is set to be movable in the axial direction of the fulcrum shaft 30 in the installation structure 38 according to the present embodiment, the present invention is not limited thereto. Therefore, the conical springs and washer may be disposed so as to set the inner race 41a of the first bearing 41 as the fixed one, and make the outer race 41b, which is the other one, to be movable in the axial direction, for example. In addition, although the inner races of the first bearing 41, the second bearing 42 and the third bearing 43 are each set to be slidable only by the amount of the gap C, and the first bearing 41, the second bearing 42 and the third bearing 43 are constituted as an installation structure of bearings that are movable in a direction in which there is no longer an axial gap or radial gap in the present embodiment, the present invention is not limited thereto. For example, similarly to the first bearing 41, the second bearing 42 and the third bearing 43, for the sixth bearing 46, fifth bearing 45 and fourth bearing 44 as well, it is also possible to constitute as an installation structure of bearing in which a gap is provided in a center axial direction of the fourth bearing 44, and only ones of either the inner races or the outer races of the sixth bearing 46, the fifth bearing 45 and the fourth bearing 44 are movable in a direction in which there is no longer an axial gap or radial gap in each bearing.

It should be noted that the present invention is not limited to the aforementioned embodiment, and that modifications, improvements, etc. within a scope that can achieve the object of the present invention are included in the present invention. For example, although the welding gun 10 has been explained as an X-type welding gun that opens and closes the first gun arm 11 and the second gun arm 12 fixed to each other with the fulcrum shaft 30 supported by the installation structure 38 as the pivot point in the aforementioned embodiment, the present invention is not limited thereto. The installation structure may be constituted as a C-type welding gun that fixes either one of the first gun arm 11 and the second gun arm 12, and opens and closes the other one. Furthermore, the installation structure of bearings according to the present invention is not limited to a welding gun as the installation structure of bearings that support a fulcrum shaft for pivotally supporting to be rotatable two arms used for sandwiching an object, for example, and the present invention can be applied to various other purposes. In addition, although an installation structure of bearings has been explained in the aforementioned embodiment as a structure constituted by three bearings, the number of bearings constituting the installation structure of bearings according to the present invention may be 1, or any number according to the implementation.

What is claimed is:

1. An installation structure of a bearing that supports a fulcrum shaft pivotally supporting a gun arm constituting a welding gun to be rotatable, and receives a combined load of an axial load acting in an axial direction of the fulcrum shaft and a radial load acting in a radial direction of the fulcrum shaft,
wherein, in the installation structure,
one race among an inner race and an outer race constituting the bearing is fixed in an axial direction, and an other race among the inner race and the outer race is Installed to be movable, relative to the one race among the inner race and the outer race, in a direction in which there is no longer a radial gap or axial gap between a revolving body, disposed between the inner race and the outer race to freely revolve, and the inner race and the outer race, respectively.

2. The installation structure according to claim 1, wherein a conical spring is installed between tightening means that fix the bearing by tightening the bearing so as to support the fulcrum shaft relative to the gun arm.

3. A method for installing a bearing that supports a fulcrum shaft pivotally supporting a gun arm constituting a welding gun to be rotatable, and receives a combined load of an axial load acting in an axial direction of the fulcrum shaft and a radial load acting in a radial direction of the fulcrum shaft,
wherein the method comprises steps of:
fixing one race, among an inner race and an outer race constituting the bearing, in an axial direction;
installing an other race among the inner race and the outer race to be movable in the axial direction;
causing the other race among the inner race and the outer race to move relative to the one race among the inner race and the outer race when assembling the bearing;
shifting the inner race and the outer race relatively in the axial direction; and
fixing the bearing in a state in which there is no longer a radial gap or axial gap between a revolving body, disposed between the inner race and the outer race to freely revolve, and the inner race and the outer race, respectively.

4. The method according to claim 3, further comprising a step of tightening the bearing in a state in which a conical spring is installed between tightening means that fix the bearing by tightening the bearing so as to support the fulcrum shaft relative to the gun arm.
